(19) United States
(12) Patent Application Publication
(10) Pub. No.: US 2010/0119100 A1
(43) Pub. Date: May 13, 2010

(54) Electronic voice pad and utility ear device

(76) Inventor: Jeffery Shane DeVine, Aptos, CA (US)

Correspondence Address: Walt Froloff, 273D Searidge Rd, Aptos, CA, 95003, US

(21) Appl. No.: 12/291,800

(22) Filed: Nov. 13, 2008

(51) Int. Cl. H04R 25/00

(52) U.S. Cl. 381/381

(57) ABSTRACT

The present invention is an external ear attachable electronic ear utility device, having logic for processing input-output signals to the ear device upon user demand from mechanical switches or audio input, and logic for storing user audio input in the device memory such that the external ear device platform can be extended for alternative hands free visual free operation while making and retrieving stored verbal notes/messages. The ear device can also have functions to identify audio input for preset voice commands, logic for programming to record and playback audio signals on user selection or on audio voice command, a trip route recorder and electronic bread crumbs utility for finding ones way back to a start position using GPS stored point locations. Other utilities include an RFID signal detection and warning, as well as a purely audio interface directional compass.

### BACKGROUND

### Field of the Invention

The present invention generally relates to externally worn hearing devices and specifically to additional utilities such as verbal commanded recording and playback of short notes, and scheduler for short reminders and memory triggers.

### Hearing Aids

People of all ages around the world suffer from hearing loss. Studies show that many people who purchase hearing aids do not wear them regularly for various reasons: physical discomfort, difficult or problematic device operation, social embarrassment from being labeled “old,” and others. What is needed is an aid that obviates/remedies these problems associated with wearing a hearing aid, while simultaneously bringing new technologies to the art.

Some of the social stigma associated with wearing hearing aids can be over come with designs that appear to be other than a hearing aid, for example a blue tooth device. Today more and more people are wearing cellular telephone headsets. What is needed is a hearing aid that looks identical to a cellular telephone headset allows the wearer to benefit from wearing a hearing aid, while avoiding the social stigma/embarrassment associated with visible old fashioned hearing aids. What is needed are ways to disguise hearing aids while adding functionality to a small device which can serve a multiplicity of purposes.

Furthermore, state of the art miniature hearing aids that fit into the ear, or that are hidden within the ear canal are often uncomfortable, difficult to operate and maintain, and costly. What is needed is a hearing aid that is durable, fits comfortably on the outside of the ear, has large easy to operate controls, a large built-in rechargeable battery or readily available power source, and can be manufactured and maintained economically.

What are needed are hearing aids that are as good as custom designed and fitted to a specific individual, but made to fit any ear comfortably. What is needed is a hearing aid that can be donned easily, and readily removed when not in use as during sleeping, showering, etc. and made in economic scales to reduce costs.

What is needed is hearing aid designed to amplify specific sound frequencies as identified and prescribed by a medical professional but that can be manufactured to provide simple sound amplification only, and thus benefit any wearer for an affordable price.

With the proliferation of ear phones, the external ear device has become a mature interface for devices. What is needed are additional utilities, which can be embedded into these externally placed ear devices, which would add functionality to a ready interface.

### SUMMARY

The present invention discloses an external ear attachable electronic ear utility device, having an audio speaker component coupled to the housing, an audio input component coupled to integrated electronic circuitry contained in the housing, an integrated electronic processing component coupled to the audio input, an audio output and other electronic input-output components, component memory, an analog to digital converter for digitizing the audio signal, a digital signal processing coupled to a processing component and the input-output signals, for processing the digitized signal, logic for processing input-output signals to the ear device upon user demand from mechanical switches or audio input, and logic for storing user audio input in the device memory such that the external ear device platform can be extended for alternative hands-free and visual free operation while taking verbal notes. The ear device can also contain logic to identify audio input for preset voice commands, logic for programming to record and playback audio signals on user selection or by audio voice command, a trip route recorder and electronic bread crumbs utility for finding one's way back to a start position using GPS stored point locations. Other utilities include an RFID signal detection and warning, as well as a purely audio interface directional compass.

### BRIEF DESCRIPTION OF DRAWINGS

FIG. 1 shows a side, front and top view of an electronic voice pad and utility ear device with the voice record and playback function using an external interface in accordance with an embodiment of the invention.

FIG. 2 is an isometric illustration of an electronic voice pad and utility ear device with the voice record and playback function using an external interface, in accordance with an embodiment of the invention.

FIG. 3 is a high level electronic components and data flow diagram of an electronic voice pad and utility ear device internals in accordance with an embodiment of the invention.

FIG. 4 is a high level function flow diagram of an electronic voice pad and utility ear device internals in accordance with an embodiment of the invention.

FIG. 5 is a high level flow chart of a personal back track utility ear device function in accordance with an embodiment of the invention.

FIG. 6 is a graphical depiction of the GPS data from a journey for the personal back track utility ear device function in accordance with an embodiment of the invention.

FIG. 7 is a graphical depiction of the GPS data for a voice compass utility ear device function in accordance with an embodiment of the invention.

### DETAILED DESCRIPTION

Specific embodiments of the invention will now be described in detail with reference to the accompanying figures.

In the following detailed description of embodiments of the invention, specific details are set forth in order to provide a more thorough understanding of the invention. However, it will be apparent to one of ordinary skill in the art that the invention may be practiced without these specific details in lieu of substitutes. In other instances, well-known features have not been described in detail to avoid unnecessarily duplication and complication.

### OBJECTS AND ADVANTAGES

The present invention provides a simple electronic device to be worn about the ear, which allows wearers to extend utility to their current ear devices in several ways.

An object of the invention adds a voice notepad functionality to an external worn ear device. The wearer would have a digital message recording and playback device provided by the ear device. This functionality can be used to conveniently record and playback personal messages such as “I parked the car on level 3, section C,” “pick up a loaf of bread on the way home from work,” etc.

An object of the invention is to integrate utility into an existing external ear device platform. A Bluetooth device is external to the ear and contains the volume necessary to house the circuitry and components for other utilities as part of the present invention. Also, many of the same components in an external ear device can be used for other functions, as platforms of most electronic devices do.

An object of the invention to render the design to appear much like a modern “blue tooth” cellular telephone headset. Because the invention may be integrated with a hearing aid, a hearing aid in the guise of a cellular telephone headset allows the wearer to benefit from wearing a hearing aid, while avoiding the social stigma/embarrassment associated with visible old fashioned hearing aids. Thus the voice pad or “vpad” and other ear device utilities travel incognito.

Another object of the invention is to provide a voice activated voice response directional compass. A user will simply orally command “direction” and the ear device voice compass will respond with “north east” or “43 degrees from north”, calculating the direction from a projection using the last two or three GPS lat/long data points read.

Another object of the invention is a route back track or “vTracker”. Individuals in unfamiliar territory will select trace back feature and routing GPS data will be stored, for recall upon demand later, directing the individual back to the starting point. The object is to be further used by hikers on trails where sufficient directional signs are not posted, or pedestrians in unfamiliar area, much like a visual GPS can provide in an automobile, but not visual, aural feedback is given.

Another object of the invention is to add more electronic functionality to an external hearing aid device. This is possible because the state of the art continues to reduce the size of many of these components and some can be integrated into an external ear device platform. Some of these functions and features would include an RFID reader detector, voice compass or “vCompass”, voice back-tracking device, pager, medical/emergency alert, radio transmitter, AM/FM emergency radio, two-way local radio, digitally recorded music or telephone compatibility, etc.

### Voice Notepad

An embodiment of the invention integrates electronics into an external supported ear device, with an audio record and playback feature such that an individual can make verbal notes which are recorded for later playback. The memory is solid state and is sufficiently dense to allow such a feature to be embedded in a current size external ear device.

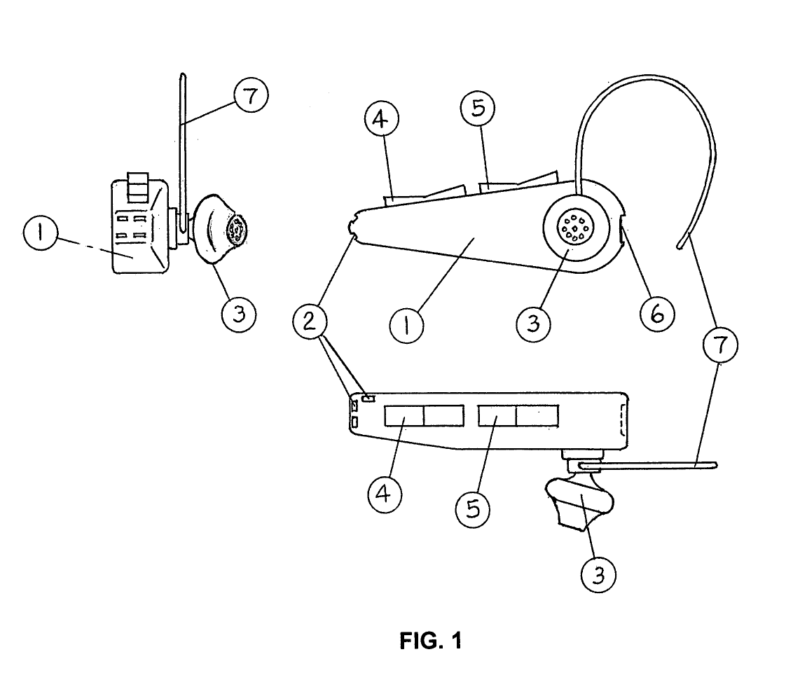

FIG. 1 shows a side, front, and top view of an electronic voice pad and utility ear device with the voice record and playback function using an external interface in accordance with an embodiment of the invention. The device embodiment housing 1 is narrowed at the speaker 2 end and somewhat wedge shaped with a protruding ear piece 3 which fits into a typical user's ear. The housing 1 is supported externally through a wire type ear wrap 7 which fits over the ear.

The device housing 1 may be mounted upon the user's outer ear with the ear wrap 7, but could also be mounted on the user's helmet, hat, headband, headset, eyeglasses, or any article of clothing and/or object carried by the user.

Two mechanical switches 4 and 5 are shown, one for turning the device on-off and the other for record-playback mode. A notched rotation switch 6 protruding from the housing end opposite the speaker end serves as a volume control dial and can also act as an on/off switch additionally. This embodiment looks very much like a Bluetooth telephone headset. The is the intent for design, as this disguise enhances the utility for some functions of the device in hearing.

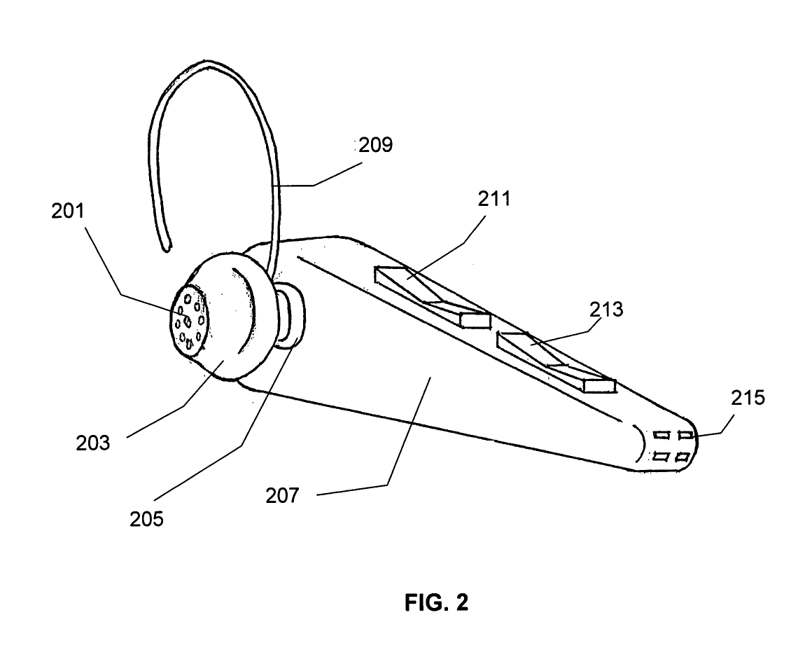

FIG. 2 is an isometric illustration of an electronic voice pad and utility ear device with the voice record and playback function using an external interface, in accordance with an embodiment of the invention. The housing 207 holds the internal embedded software and electronic hardware components. With the exception of the software functions provided, most of the hardware components are typical to Bluetooth headsets and external ear hearing aids. This is by invention, as manufacturing costs can be best ascertained and projected from known data where there is historical data of similar consumer goods. Economies of scale can also be engaged where similar hardware items are already in production. The housing 207 sports voice input openings 215 on the device distal end and a protruding base 205 for the ear speaker 203 and audio output vents 201. The device housing is supported by a wire like ear wrap around 209 the user's ear base, which allows the user to appear as if they were wearing a Bluetooth device. The button switches 211 and 213 provide a hardware interface to the power On-Off the device adjust volume, and select record or playback of the voice notes/messages. These can also be voice activated as in an “open mic”.

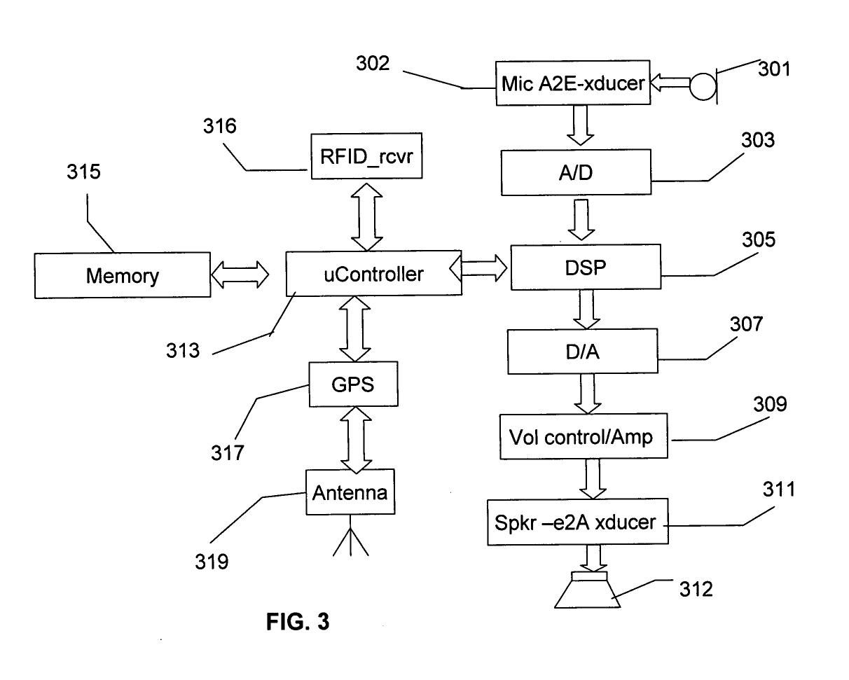

FIG. 3 is a high level electronic components and data flow diagram of an electronic voice pad and utility ear device internals in accordance with an embodiment of the invention. An ON signal from the user interface will power up and initialize the internal components including the mic 301, acoustic to electronic signal transducer 302, analog-to-digital converter 303, digital signal processor 305, analog-to-digital converter 307, volume control amplifier 309, electronic to acoustic signal transducer 311, speaker 312, microcontroller or CPU 313, memory 315, RFID receiver 316, GPS chipset 317, and antenna 319. A verbal command issued by the user will enter the microphone 301 and be transformed to electrical signal by the audio to analog signal transducer 302. This analog electrical signal representing the verbal input is then changed into digital signal by the Analog-to-Digital Converter 303. This digital signal is filtered by the Digital Signal Processor 305 to extract only the programmed relevant signal wanted and forwarded to the microcontroller 313 for further processing of the command and/or audio data. The controller 313 will behave programmatically to parse the command and execute programs in compliance with the command to act on data received or stored. For example, the command may be to store audio data, at which the executive program will dispatch routines, generally from memory 315, to allocate storage, successfully store the incoming data and return execution upon successful storage. Many firmware housekeeping chores will also be executed by the controller in the operation of input-output devices such as GPS 317 and associated equipment 319 to obtain additional data or send out results, alarms or alerts. Upon a user selection of replay a voice note/message, the controller 313 will parse the command to identify the task, dispatch the routine to find the audio data location, then retrieve the audio data from memory 315, package the digital data and send to the DSP 305 for signal processing, which then gets forwarded the Digital-to-Analog Converter 307 to transform the data to audio signal. The audio signal may have a volume controller 309 to regulate the audio signal amplitude before it is sent to the speaker 312 or other output audio device. The addition of an RFID receiver 316 component can add utilities in yet another embodiment of the invention for the ear device. The RFID 316 component will detect RFID signal in the general vicinity and alert the user via the controller 313 and output device 312 that they are being scanned or that RFID scanning in going on in the area. This RFID utility, “vRFID”, integrated into an ear device platform adds more functionality in a Swiss army knife fashion to an external ear device.

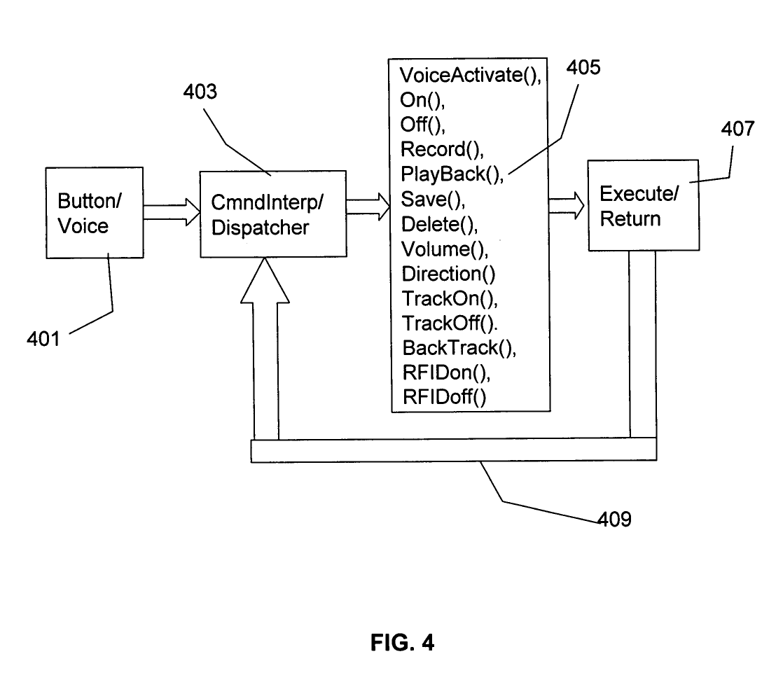

FIG. 4 is a high level function flow diagram of an electronic voice pad and utility ear device internals in accordance with an embodiment of the invention. An embodiment of the invention will have multiple functions, which require hardware and software components working together. The software environment may have a simple executive or a more complicated operating system. The executive program 403 will run a executable code to accept and interpret voice commands and input data from I/O, then to dispatch routines to fulfill the functions for the command. Upon determining the command, the Command Interpreter will dispatch one or more routines 405 in its features offered. For example, in an embodiment of the invention, a button 401 can signal a task which is interpreted by the command interpreter 403 which then executes the appropriate routine 405. The command dispatcher 403 can also dispatch a VoiceActivate( ) routine from a set of routines 405 which accepts audio input at program times, which enables the device to accept voice commands. These are accepted at the microphone and forwarded to the VoiceActivate( ) routine which receives voice command processed to a command packaged format, which is then interpreted by the VoiceActivate( ) routine to accept for example “Record Note X”, “Replay Note Y”, “Direction”, “On” “Off” “TrackOn” “TrackOff” “RFIDon”, “RFIDoff”, etc from the input microphone which are then processed for routines to dispatch in satisfaction of the voice command. The voice command “On” will dispatch execution of routine Ono, which will turn power circuits on for select components and initialize firmware. The “Off” command will dispatch Off( ) routine which closes down components. “Record Note 1” will dispatch the Record( ) routine with the #1 note. “Replay” or “Playback note 1” will dispatch the Playback( ) routine with the #1 argument. This command will then go find where the note #1 was stored and retrieve that note, then push this on to the speaker for ultimate output to the user. “Save trip X”, Save note Y” will dispatch the Save( ) routine with the “trip X” or “note Y” arguments, which upon execution 407 will perform the request and return 409 to the command interpreter 403 to await further commands. In like fashion, voice commands, pre-set comparison signature for each such as “Direction”, “Track #1”, “Track off”, “Back track” will dispatch the Direction( ), TrackOn( ), TrackOff( ), Backtrack( ) routines respectively to execute and return to await further commands. “RFID on” turns the RFIDon( ) and any RFID detected will send alert output to the user, informing them of RFID in the vicinity. Other voice commands will be pre-set to compare the input with interpreter command signatures which will trigger the commands to perform. One skilled in the art can integrate these components in an electronically integrated ear device in FIG. 3 and housing shown in FIG. 2, along with other utilities in the form of firmware burned into the memory of the device.

In another embodiment, the voice pad can have a very simple voice command vocabulary, adding almost negligible memory and logic burdens. These could be simply be reduced to a four command set:

a. “vpad record”

b. “vPad playback”

c. “vpad save”

d. “vPad erase”

In yet another embodiment, once the command “vPad record” or “vPad playback” is used the device functions only in the note/message mode until a silent pause of a certain duration is experienced, at that time the device resumes telephonic functions, hearing aid operation, compass function, etc. Disparate function operations can be timed out or command introduced with the function forming the pre-command identifying the function, as in “vPad”, “vTracker”, “vCompass”, “vRFID”, etc

Voice Interface Personal Tracking Ear Device

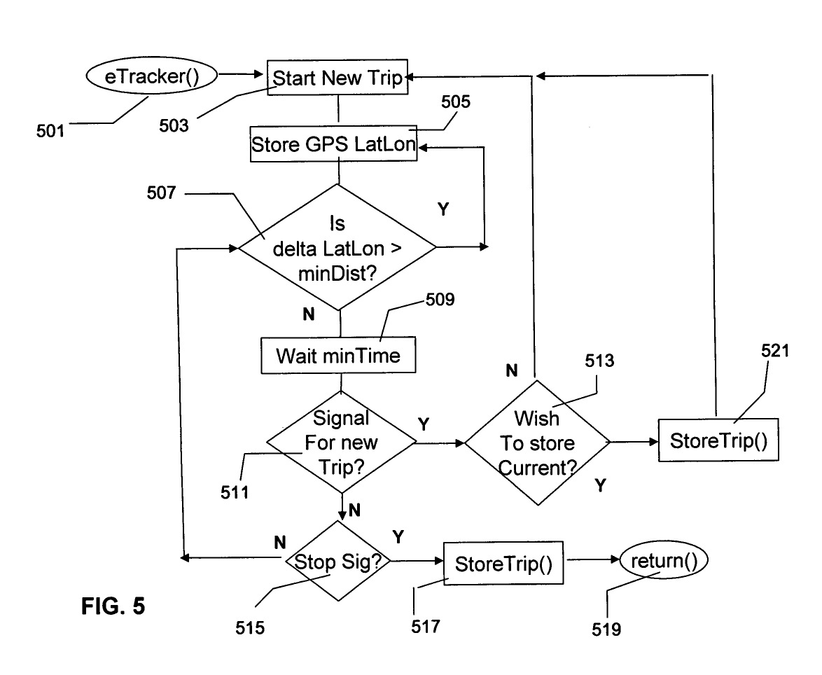

FIG. 5 is a high level flow chart of a electronic bread crumb device for a personal back tracking utility ear device function embodiment of the invention. At the command dispatch that tracking is to be enabled 501, the program sets up the housekeeping for storing a string of GPS data points in memory for later retrieval and processing. As the user moves, the program stores GPS latitude and longitude pairs 505 of locations traversed. The distance between stored points must exceed a set minimum distance 507. The program thread loops back to store where the minimum distance is exceeded 505 and waits a minimum time 509 increment otherwise. If a signal for a new trip is received 511, the user is prompted to store the old trip 513 and/or the logic loops back to start a new trip 503. Storing a trip entails saving the string of GPS points from the start to end o user selected signal defining the trip, hike, jaunt or journey under a prompted or defaulted label. If a stop trip signal 516 is received, the current GPS tracking process stores 517 the last trip and returns to the executive 519

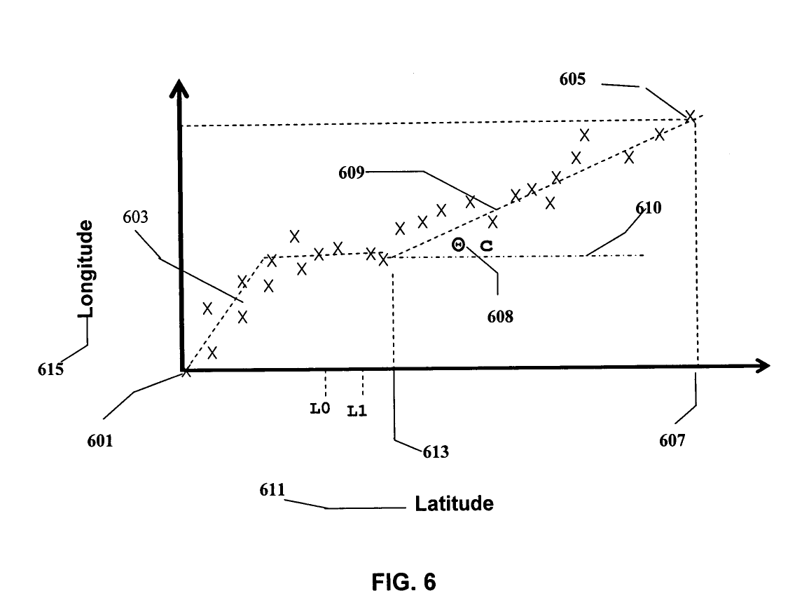

FIG. 6 is a graphical depiction of the GPS data from a journey for the personal back track utility ear device function in accordance with an embodiment of the invention. The user selects the starting point at an origin 601 of latitude 613 and longitude 615 axis. The x's represent GPS data points automatically taken along the route upon a “Back track” verbal command and the points latitude and longitude coordinates are stored in memory for retrieval and processing on demand. Segmented regression curves 603 609 can be made through the stored GPS points so that a more direct route can be navigated from the end 605 to the start point 601 of the marked journey by using the stored GPS locations from a stack or other software structure. Major turning points 613 can be found from slope changes 608 using Cartesian coordinate geometry regression curve slopes 608, typically delta longitude/delta latitude in the FIG. 6. Since the longitude 615 always points north and south and the latitude 611 points east and west, it is a simple slope calculation to provide the angle 608 with any direction from north. Thus, in backtracking, a user can be guided by voice response steering the user where the GPS coordinate current is not converging on the next previous stored GPS data point. For example a user back tracking from a return point 605 will register GPS reading which will be compared with the next previous data point for GPS latlon coordinate and if with a current registered higher longitude a “left slightly” verbal que is given or if a current registered lower longitude than the previous GPS data point, a “right slightly” verbal que is given and so forth.

Interactive Voice Compass

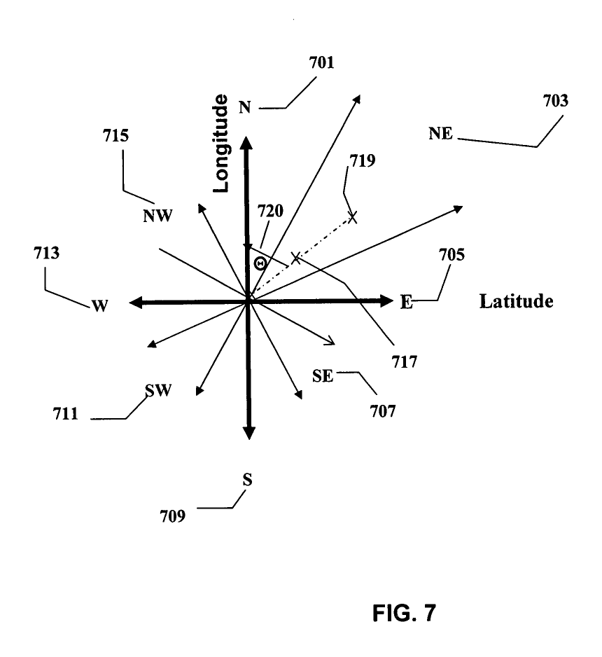

FIG. 7 is a graphical depiction of the GPS data for a voice interactive compass utility ear device function in accordance with an embodiment of the invention. The points of the compass are North 701 South 709 along the longitude axis and East 705 West 713 Latitude axis. Compass directions in between the four primary points, Northeast 703, Southeast 707, Southwest 711 and Northwest 715 can be defined in a line slope manner such that GPS points 717 719 can be assigned a general compass direction amongst the eight given depending on at least the last to GPS reading taken. Two GPS data points, an initial and final, define a direction of travel. Going from a lat-lon location 717 to a GPS lat-lon location 719 provides the coordinates to calculate a slope, given that the initial position is an origin. The slope m is calculated in typical fashion 2 dimensional coordinate system m=(lat_{—}1−lat_{—}2)/(lon_{—}1−lon_{—}2). The slope can then be mapped to one of the 8 compass directions to inform a user who has issued a “direction” verbal command to receive a response from the ear device speaker of “Northeast” or and angle theta 720, arctan(m) from North. An embodiment of the invention thus provides advantages of hands free operation, more precision than a regular magnetic compass since a magnetic north correction is not required, and visual focus is not a distraction.

Therefore, while the invention has been described with respect to a limited number of embodiments, those skilled in the art, having benefit of this invention, will appreciate that other embodiments can be devised which do not depart from the scope of the invention as disclosed herein. Accordingly, the scope of the invention should be limited only by the attached claims. Other aspects of the invention will be apparent from the following description and the appended claims.

What is claimed is:

1. An electronic apparatus providing utility to external ear devices comprising:
an attachable external ear housing containing the device electronic components,
a audio speaker component coupled to the housing,
an audio input component coupled to integrated electronic circuitry contained in the housing,
an integrated electronic processing component coupled to the audio input signal, and an audio output components,
at least one memory,
an analog to digital converter for digitizing the audio signal,
a digital signal processing coupled to a processing component and the input-output signals, for processing the digitized signal,
logic for processing input-output signals to the ear device upon user demand from mechanical switches or audio input, and
logic for storing user audio input in the device memory,
whereby the external ear device platform can be extended for alternative hands free visual free operation while taking verbal notes.

2. An electronic apparatus providing utility to ear devices as in claim 1 wherein the logic comprises programming to identify audio input for preset voice commands and dispatch logic routines upon voice command identification.

3. An electronic apparatus providing utility to ear devices as in claim 1 wherein the logic comprises programming to record and playback audio signals on user selection or by audio voice command.

4. An electronic apparatus providing utility to ear devices as in claim 1 further comprising GPS electronics coupled to hardware components and logic providing a input voice commandered voice output directional compass, aurally providing the compass direction projected from the last two or more GPS points received.

5. An electronic apparatus providing utility to ear devices as in claim 1 further comprising GPS electronics and logic for personal tracking utility, recording and storing into the memory, GPS coordinates at selected intervals during a user selected journey.

6. An electronic apparatus providing utility to ear devices as in claim 5 further comprising GPS electronics and logic for aurally steering a user from an end to the start of a selected recorded journey using stored audio verbal commands used in audible directing a users path back to the journey start.

7. An electronic apparatus providing utility to ear devices as in claim 1 further comprising RFID component circuitry and logic which alerts the user upon detection of RFID frequency signals within a pre-selected proximity upon user function selection.

8. An electronic apparatus providing utility to ear devices as in claim 1 further comprising audio signal amplification logic.

9. An electronic apparatus providing utility to external ear devices comprising:
an attachable external ear housing containing the device electronic components, a audio speaker component coupled to the housing,
an audio input component coupled to integrated electronic circuitry contained in the housing,
an integrated electronic processing component coupled to the audio microphone input signal, and an audio speaker output,
at least one memory,
an analog to digital converter for digitizing the audio signal voice command to a digital signal,
a digital signal processing coupled to a processing component and the input-output signals, for processing the digitized signal to a preset voice command signature,
a GPS set of electronic components and logic for storing and processing received lat-lon positions upon user demand,
logic for processing input signals from the audio input component upon user command,
logic for processing output signals to a speaker from pre-stored compass direction text and numbers, and
logic for storing pre-converted audio input voice signatures into the device memory,
logic for matching pre-converted user audio input voice signatures with user voice commands,
whereby input voice commands trigger logic to process stored GPS lat-lon positions which upon aural output provide compass direction projected from the last two or more GPS points received, providing hands free visual free operation while obtaining compass direction.

10. An electronic apparatus providing utility to ear devices as in claim 9 further comprising audio signal amplification logic.
